(19) United States
(12) Patent Application Publication
(10) Pub. No.: US 2023/0095884 A1
(43) Pub. Date: Mar. 30, 2023

(54) DETECTING OUT-OF-BAND SIGNALS IN A WELLBORE USING DISTRIBUTED ACOUSTIC SENSING

(71) Applicant: Halliburton Energy Services, Inc., Houston, TX (US)

(72) Inventors: Andreas Ellmauthaler, Houston, TX (US); Mikko K. Jaaskelainen, Houston, TX (US); Glenn Wilson, Houston, TX (US); Henry Clifford Bland, Calgary (CA)

(21) Appl. No.: 17/490,073

(22) Filed: Sep. 30, 2021

(51) Int. Cl. G01V 1/48; G01H 9/00; G01V 1/30

(52) U.S. Cl. CPC G01V 1/48; G01H 9/004; G01V 1/307; G01V 2210/1429

(57) ABSTRACT

A distributed acoustic sensing (DAS) system for determining an acoustic event may include an interferometer and an acoustic event detection processing device. The interferometer may measure DAS data from sensed signals from a sensing fiber deployed in a wellbore. The acoustic event detection processing device may determine an acoustic event in the wellbore from an out-of-band signal using the DAS data by performing operations. The operations can include determining a first acoustic event and a second acoustic event from the DAS data. The operations can include determining a first set of aliased frequencies from the first acoustic event and a second set of aliased frequencies form the second acoustic event. The operations can include determining, using an intersection of the first set of aliased frequencies and the second set of aliased frequencies, a frequency or amplitude of out-of-band signals that are usable to determine the at least one acoustic event.

### TECHNICAL FIELD

The present disclosure relates generally to wellbore sensing operations and, more particularly (although not necessarily exclusively), to detecting out-of-band signals in a wellbore using distributed acoustic sensing.

### BACKGROUND

Distributed acoustic sensing (“DAS”) is a rapidly evolving distributed fiber optic sensing technology that utilizes phase-sensitive or intensity-sensitive optical time-domain reflectometers (“OTDR”) or phase-sensitive optical frequency-domain reflectometers (“OFDR”) to detect signals from optical fibers. DAS systems can be used for detecting acoustic events in a wellbore with the sensing fiber permanently installed in a cable as part of the completion, or otherwise retrievably conveyed into the wellbore via coiled tubing, wireline, or slickline operations. For example, data acquired using DAS systems can be used for three-dimensional and four-dimensional vertical seismic profiling, hydraulic fracture stimulation monitoring, production flow monitoring, leak and sand detection, microseismic monitoring, cross-well strain sensing and more.

### BRIEF DESCRIPTION OF THE DRAWINGS

FIG. 1 is a schematic view of a well system with a distributed acoustic sensing system for determining out-of-band signals according to one example of the present disclosure.

FIG. 2 is a block diagram of a distributed acoustic sensing system for determining out-of-band signals according to one example of the present disclosure.

FIG. 3 is another schematic view of a well system with a distributed acoustic sensing system for determining out-of-band signals according to one example of the present disclosure.

FIG. 4 is a block diagram of a computing device for use in a distributed acoustic sensing system for determining out-of-band signals according to one example of the present disclosure.

FIG. 5 is a flowchart of a process for determining a frequency of an out-of-band signal using acoustic signals according to one example of the present disclosure.

### DETAILED DESCRIPTION

Certain aspects and examples of the present disclosure relate to using a distributed acoustic sensing (“DAS”) system to measure acoustic events from a wellbore associated with in-band signals, out-of-band signals, or both. A DAS system may transmit light pulses with a pulse repetition rate (e.g., 10 kHz for a given length of optical fiber). The pulse repetition rate may determine the Nyquist frequency or acoustic bandwidth, defined as half of the pulse repetition rate, of the in-band signals. Any acoustic events above the Nyquist frequency may be out-of-band signals which get wrapped around the Nyquist frequency, and may be superimposed upon the in-band signals (aliasing). When a DAS system transmits one or more light pulses at a fixed pulse repetition rate, it may be difficult to faithfully reconstruct the out-of-band signals.

The DAS system may transmit two or more light pulses of different wavelength and with differing pulse repetition rates into the sensing fiber, and determine aliased acoustic events from out-of-band signals received in the sensing fiber. An out-of-band signal may be a signal that includes frequencies that are higher than Nyquist frequencies of the two or more DAS pulse repetition rates. After transmitting two or more light pulses with differing pulse repetition rates, the DAS system may receive backscattered light associated with each of the light pulses. The backscattered light may include data regarding acoustic events sensed by the sensing fiber. If the backscattered light includes acoustic events that occur at different frequencies (aliased frequencies), the backscattered light may include out-of-band signals, and the aliased frequencies may be used to determine the frequency of the out-of-band acoustic events.

Typically, light pulses can be transmitted at a pulse repetition rate that prevents aliased frequencies in the sensed signals. A pulse repetition rate may be constrained by the length of the fiber and the speed of light in the fiber. For example, assuming a refractive index of 1.5, a fiber that is 5 km long can support a pulse repetition rate of 20 kHz, which may constrain the sensed signals to an acoustic bandwidth (or Nyquist frequency) of 10 kHz. Similarly a 20 km long sensing fiber may be limited to a 5 kHz sampling rate which may constrain the sensed signals to a 2.5 kHz bandwidth. Many subsurface signal sources that could be beneficial to measure fall outside of the Nyquist frequency. For example, the DAS signals caused by sand ingress and wellbore leaks may occur at frequencies higher than 20 kHz, which cannot be faithfully measured using current-state-of-the-art DAS processing techniques for a Nyquist frequency of 10 kHz. This in turn may severely hinder the ability of DAS to detect leaks and sand ingress, resulting in erroneous flow estimates and other difficulties. But the DAS system itself does not impose any bandwidth limitations, and thus responses above and below the Nyquist frequency can still be sensed. By transmitting multiple light pulse signals from one laser or multiple lasers at different pulse repetition rates, the signal-to-noise ratio for signals below the Nyquist frequency may be increased, and signals above the Nyquist frequency may be accurately sensed. Removing the bandwidth limit imposed by the sensing fiber length may significantly expand the sensing capabilities of DAS systems.

In some examples, DAS systems operate with multiple lasers, such as two or four lasers. The use of multiple lasers may be practiced to minimize channel fading. The lasers may simultaneously transmit light pulse signals at the same pulse repetition rate and with different wavelengths, so that the light pulse signals may have the same Nyquist frequency and may measure the same acoustic event. In one example, at least one pair of lasers may be used at a first pulse repetition rate and at least one pair of lasers may be used at a second, different pulse repetition rate to sense one or more acoustic events. If the acoustic event occurs at the same frequency for the DAS data collected at the first and second pulse repetition rate, no aliasing has occurred, which may imply that the detected same frequency is the true frequency of the acoustic event. If the acoustic event occurs at different frequencies, then aliasing has occurred, which may imply that the true frequency of the acoustic event is greater than half of the lower sampling frequency. The DAS system may determine a true frequency of the acoustic event using an intersection between a fast Fourier transform of the different frequencies.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

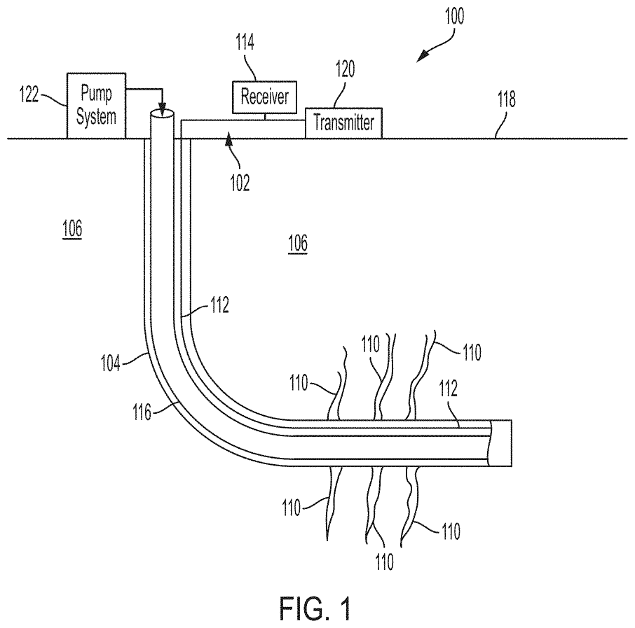

FIG. 1 is a schematic view of a well system 100 with a DAS system 102 for determining out-of-band signals according to one example of the present disclosure. A wellbore 104 may be created by drilling into a formation 106 (e.g., a hydrocarbon bearing formation). To access hydrocarbons stored within the formation 106, hydraulic fracturing or other stimulation operations may be conducted after the wellbore 104 is drilled. A hydraulic fracturing operation generally includes pumping hydraulic fracturing fluid under pressure into a section 108 of the wellbore 104. The pressure of the hydraulic fracturing fluid creates fractures 110 within the formation 106 near a fracturing plug positioned within the wellbore 104. Through these fractures 110, hydrocarbons are able to flow into the wellbore 104 more freely.

The DAS system 102 may include a length of fiber optic cable 112 that extends along a length of the wellbore 104. The fiber optic cable 112 may be permanently deployed behind casing, or may be permanently deployed in the upper completion of the wellbore; or may be permanently deployed in the upper and lower completions of the wellbore. Distributed acoustic sensing can be performed by the DAS system 102 to detect, both, in-band and out-of-band signals usable to determine acoustic events. Information may be collected from the DAS system 102 during a hydraulic fracturing operation and used to determine adjustments to parameters of the hydraulic fracturing operation. In other completions, information may be collected from the DAS system 102 during fluid production or injection operations and may be used to determine adjustments to parameters of the production or injection operation.

As illustrated, the fiber optic cable 112 may be communicatively coupled to a receiver arm 114 and a transmitter arm 120 of the DAS system 102. In operation, the fiber optic cable 112, receiver arm 114, and transmitter arm 120 may be used to perform DAS operations within the wellbore 104. For example, the transmitter arm 120 may inject light pulse signals into the fiber optic cable 112 and the receiver arm 114 may detect in-band and out-of-band signals in a backreflected signal received from the fiber optic cable 112. In one or more examples, the DAS system 102 may include an optical time domain reflectometer (OTDR) or an optical frequency domain reflectometer (OFDR). In one or more examples, the DAS system 102 may be operated in homodyne or heterodyne configurations. Any other types of reflectometers may also be used. The distributed acoustic sensing operations within the wellbore 104 may provide a mechanism to determine locations and event magnitudes of acoustic events caused by the hydraulic fracturing operations that are associated with in-band and out-of-band signals.

The fiber optic cable 112 may be attached to an outer surface of a casing 116 within the wellbore 104, suspended from a surface 118 of the wellbore 104 between the casing 116 and a wall of the wellbore 104 (e.g., within cement between the casing 116 and a wall of the wellbore 104), or positioned within the casing 116. The receiver arm 114 and the transmitter arm 120 may be positioned at the surface 118 of the well system 100. The receiver arm 114 may detect acoustic events near the fiber optic cable 112 within the wellbore 104 (such as vibration of the formation 106 resulting from seismic waves) that contribute to strain or displacement of the fiber optic cable 112.

In some examples, the receiver arm 114 may provide the acoustic events to a pump system 122 to make adjustments based on the sensed signals received from the fiber optic cable 112. As the receiver arm 114 determines the acoustic events in the wellbore 104, the pump system 122 may adjust a proppant concentration in a fracturing fluid, a pumping rate of the fracturing fluid, a fracturing fluid pressure, or any other hydraulic fracturing parameters that are adjustable to increase the hydraulic fracturing efficiency based on the acoustic data obtained from the wellbore 104.

While only a single fracturing stage is shown in FIG. 1, multiple fracturing stages may be monitored using the systems and techniques described herein. For examples, several additional fracturing stages may be located further downhole from the fractures 110, and the fiber optic cable 112 may extend into the wellbore 104 to provide monitoring in each of the additional stages. Similarly, multiple wells may be instrumented and monitored using the systems and techniques described herein. In some cases one well may be fractured and one or more wells may be used as monitoring wells. The well being fractured may use the measured data to determine fluid inflow profiles while the monitoring well measured data may be used to determine micro-seismic and or strain signals indicative of fracture properties like fracture length, fracture height, fracture width, fracture orientation, fracture growth rate, a volume associated with the fracturing operation as well as position of the volume over time. The data and information collected from the fracturing well and/or monitoring well(s) may be used to update models and/or predict future fracture properties for a given hydraulic fracture spread setpoint and/or used to model fracture growth as a function of changed fracture spread parameters where fracture spread parameters may include pressure, rate, chemical composition, proppant concentration and diverter concentration. A fracturing system may operate in a closed loop or open loop control configuration where the raw data and/or processed data may be used to operate the fracturing spread and associated equipment like pumps, blenders, valves etc.

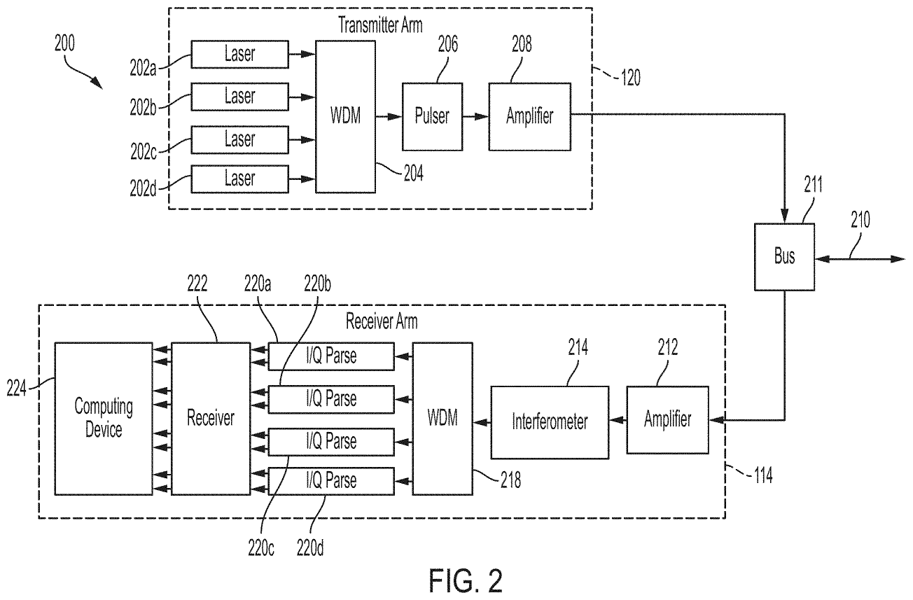

FIG. 2 is a block diagram of a DAS system 200 for determining out-of-band signals according to one example of the present disclosure. In some examples, the DAS system 200 can be the DAS system 102 depicted in FIG. 1. Other DAS system configurations may include intensity based interferometric sensing systems, OFDR based interferometric sensing systems, interferometric sensing systems based on homodyne or heterodyne sensing principles, Fabry-Perot based interferometric sensing systems and other interferometric sensing systems known to a person skilled in the art.

The DAS system 200 includes a receiver arm 114 and a transmitter arm 120. The transmitter arm 120 includes lasers 202a-d. Although four lasers 202a-d are depicted, more or fewer lasers may be included. The lasers 202a-d may each generate an optical signal, such as a continuous optical wave, to be transmitted to a sensing fiber 210. In some examples, the sensing fiber 210 can be the fiber optic cable 112 depicted in FIG. 1.

Additionally, the transmitter arm 120 may include a wave division multiplexer (“WDM”) 204, a pulser 206, and an amplifier 208. The WDM 204 may be included to combine the wavelengths of the continuous optical wave generated by the lasers 202a-d into a single signal that can be transmitted onto the sensing fiber 210. The pulser 206 may be included to generate a light pulse signal that is a square wave or another high-extinction pulse from the continuous optical wave. The amplifier 208 may be included to increase the strength of the signal's amplitude, such as when the transmitter arm 120 includes only a single laser 202. The transmitter arm 120 may then transmit the amplified light pulse signal to the sensing fiber 210. In some examples, the DAS system 200 can include a bus 211 for routing the light pulse signals to the sensing fiber 210. In some examples, each laser 202 or pair of lasers may generate optical signals at differing frequencies. Alternatively, a single laser 202 may generate multiple optical signals at differing frequencies that may be transmitted to the sensing fiber 210. In yet another example, the light pulse signal launched into the sensing fiber 210 may correspond to a frequency modulated pulse which may have been linearly chirped over several GHz.

In some examples, the receiver arm 114 may include a receiver 222 and a computing device 224. The receiver 222 may be an optical signal receiver and may receive sensed signals from the sensing fiber 210 that correspond to the light pulse signals transmitted by the transmitter arm 120. The sensed signals may include in-band and out-of-band signals. The computing device 224 may analyze the sensed signals to extract the in-band and out-of-band signals and determine acoustic events associated with the in-band and out-of-band signals.

Additionally, the receiver arm 114 may include an amplifier 212, an interferometer 214 with a delay coil 216, a WDM 218, and I/Q parse blocks 220a-d. The amplifier 212 may be included to amplify the strength of the sensed signals received from the sensing fiber 210. The interferometer 214 may be included to extract DAS data such as strain changes along the sensing fiber 210. The WDM 218 may be included to split the sensed signals into multiple signals, such as the four signals depicted in FIG. 2. The I/Q parse blocks 220a-d may be included to parse each split signal into an in-phase (I) signal and a quadrature (Q) signal. If all depicted elements are included in the receiver arm 114, the sensed signals from the sensing fiber 210 may pass through the amplifier 212, the interferometer 214 with the delay coil 216, the WDM 218, the I/Q parse blocks 220a-d, and the receiver 222 and then be transmitted to the computing device 224 for processing. In some examples, the bus 211 can rout the sensed signals from the sensing fiber 210 to the receiver arm 114. A person skilled in the art would appreciate that e.g. a single laser system may be significantly simpler to implement where many components like WDM's pulsers, amplifiers etc. may be omitted based on system performance requirements and the pulse repetition rate may be varied over time.

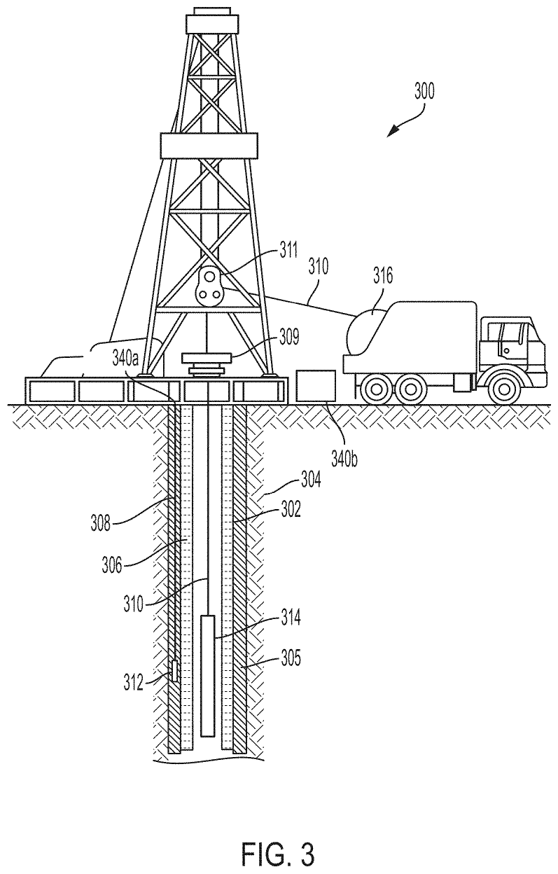

FIG. 3 is another schematic view of a well system 300 with a DAS system for determining out-of-band signals according to one example of the present disclosure. The well system 300 includes a wellbore 302 that extends through various earth strata, including a hydrocarbon bearing subterranean formation 304 or wellbore 302 may be a wellbore used for geothermal energy harvesting or wellbore may be used for injection of fluids like water, CO₂, or any combination of gases or liquids used in subterranean reservoirs or formations. A casing string 306 extends from the surface 309 to the subterranean formation 304. The casing string 306 can provide a conduit through which formation fluids, such as production fluids produced from the subterranean formation 304, can travel from the wellbore 302 to the surface 309. The casing string 306 can be coupled to the walls of the wellbore 302 via cement. For example, a cement sheath 305 can be positioned or formed between the casing string 306 and the walls of the wellbore 302 for coupling the casing string 306 to the wellbore 302.

The well system 300 can also include at least one well tool 314 (e.g., a logging-while-drilling tool). The well tool 314 can be coupled to a wireline 310, slickline, or coiled tubing that can be deployed into the wellbore 302. The wireline 310, slickline, or coiled tubing can be guided into the wellbore 302 using, for example, a guide 311 or winch. In some examples, the wireline 310, slickline, or coiled tubing can be wound around a reel 316. Other means of placing an optical fiber in the wellbore 302 may include the Halliburton ExpressFiber™ disposable fiber cable commonly used for monitoring cross-well information like e.g. strain, temperature and micro-seismic events.

In some examples, the well system 300 can include one or more DAS systems. The DAS systems can detect acoustic events in the wellbore 302, including acoustic events from both in-band and out-of-band signals. One example of a DAS system can include a transceiver 340a coupled to a fiber optic cable 308. A transceiver can include both a receiver and a transmitter, such as the receiver arm 114 and transmitter arm 120 depicted in FIGS. 1 and 2. The fiber optic cable 308 can be positioned on or embedded within a cement sheath 305 or a casing string 306, or can be positioned elsewhere in the wellbore 302. The transceiver 340a can be positioned aboveground (e.g., above the well surface 309) or below ground. In some examples, one or more sensors 312 can be coupled to the fiber optic cable 308. The sensors 312 can detect an environmental condition in, or other characteristic of, the wellbore 302 and transmit associated data to the transceiver 340a. Examples of the sensor 312 can include a temperature sensor, pressure sensor, vibration sensor, acoustic sensor (e.g., a microphone), strain gauge, flow sensor, tilt sensor, accelerometer, gyroscope, inclinometer, or any combination of these. Multiple sensors may be distributed along fiber optic cable 308. For example, a pressure sensor can be coupled to the end of the fiber optic cable 308 or multiple pressure sensors may be distributed along fiber optic cable 308 for detecting a pressure in the wellbore 302 and transmitting associated pressure data via light pulse signals to the transceiver 340a. Fiber optic cable 308 may have multiple single-mode and/or multi-mode optical fibers where some may be used for DAS, Distributed Temperature Sensing (DTS), Distributed Strain Sensing (DSS) or point sensors and any combination thereof.

The well system 300 can additionally or alternatively include another DAS system. For example, another DAS system can include a transceiver 340b coupled to the wireline 310. The wireline 310 can include a fiber optic cable. In some examples, the fiber optic cable can be terminated by the well tool 314 or a sensor of the well tool 314. For example, the well tool 314 can include a sensor coupled to the end of the fiber optic cable. In some examples, the sensor can be configured substantially the same as sensor 312. The sensor can detect environmental conditions in the wellbore 302, characteristics of the well tool 314, or other parameters and transmit associated sensor signals via light pulse signals to the transceiver 340b. The sensor signals can include out-of-band signals that can be detected by the transceiver 340b.

Any number or configuration of DAS systems can be included in the wellbore 302. For example, multiple fiber optic cables can be coupled to a single transceiver 340a. In one such example, fiber optic cable 308 and a fiber optic cable of wireline 310 can both be coupled to transceiver 340a.

In some examples, the DAS system (including the system for detecting out-of-band signals) can be implemented in other contexts. For example, the DAS system can be a part of a pipeline system (e.g., gas, oil, or water pipeline systems), civil structure (e.g., a nuclear, energy, or communication system), transportation system (e.g., a railroad system), a security system (e.g., for securing supply routes or border monitoring), or a telecommunication system (e.g., for fiber optic communications).

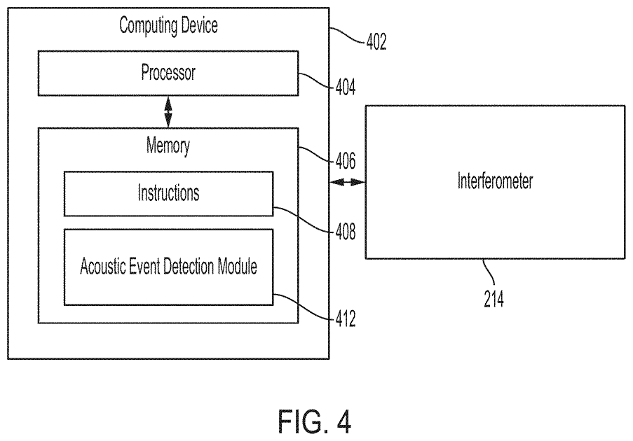

FIG. 4 is a block diagram of a computing device 402 for use in a DAS system for determining out-of-band signals according to one example of the present disclosure. The computing device 402 may be the computing device 224 depicted in FIG. 2, or a computing device included in or communicatively coupled to the transceivers 340a or 340b of FIG. 3. In some examples, the components shown in FIG. 4 can be integrated into a single structure. For example, the components can be within a single housing. In other examples, the components shown in FIG. 4 can be distributed (e.g., in separate housings) and in electrical communication with each other.

The computing device 402 can include a processor 404 and a memory 406. The processor can execute one or more operations for operating the computing device 402. The processor 404 can execute instructions 408 stored in the memory 406 to perform the operations. The processor 404 can include one processing device or multiple processing devices. Non-limiting examples of the processor 404 include a Field-Programmable Gate Array (“FPGA”), an application-specific integrated circuit (“ASIC”), a microprocessor, etc.

The processor 404 can be communicatively coupled to the memory 406. The non-volatile memory 406 may include any type of memory device that retains stored information when powered off. Non-limiting examples of the memory 406 include electrically erasable and programmable read-only memory (“EEPROM”), flash memory, or any other type of non-volatile memory. In some examples, at least some of the memory 406 can include a medium from which the processor 404 can read instructions 408. A computer-readable medium can include electronic, optical, magnetic, or other storage devices capable of providing the processor 404 with computer-readable instructions or other program code. Non-limiting examples of a chip(s), ROM, random-access memory (“RAM”), an ASIC, a configured processor, optical storage, or any other medium from which a computer processor can read instructions. The instructions 408 can include processor-specific instructions generated by a compiler or an interpreter from code written in any suitable computer-programming language, including, for example, C, C++, C#, etc.

In some examples, the memory 406 can include an acoustic event detection module 410 for causing the processor 404 to receive and process signals output by an interferometer 214 included in a transceiver or a receiver. For example, the acoustic event detection module 410 can cause the processor 404 to determine, from DAS data received from a wellbore, a first acoustic event, and a second acoustic event. The processor 404 may determine aliased frequencies for the first acoustic event and the second acoustic event and may determine a frequency of an acoustic event with an out-of-band signal using the aliased frequencies.

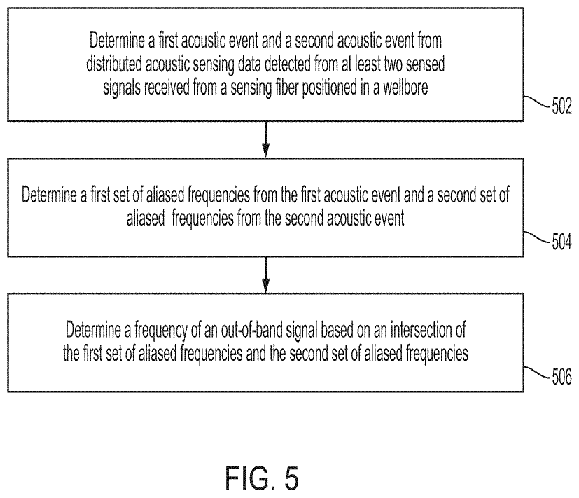

FIG. 5 is a flowchart of a process for determining a frequency of an out-of-band signal using acoustic signals according to one example of the present disclosure. In some examples, the processor 404 can implement some or all steps shown in FIG. 5. Other examples can include more steps, fewer steps, different steps, or a different order of the steps than is shown in FIG. 5. The steps of FIG. 5 are discussed below with reference to the components discussed above in relation to FIGS. 1-4.

At block 502, the processor 404 determines a first acoustic event and a second acoustic event from DAS data detected from at least two sensed signals received from a sensing fiber positioned in a wellbore, such as the fiber optic cable 112 in wellbore 104 of FIG. 1 or the fiber optic cable 308 in wellbore 302 of FIG. 3. The at least two sensed signals may correspond to at least two light pulse signals outputted by a transmitter to the sensing fiber. The at least two light pulse signals may have different pulse repetition rates and may include an out-of-band signal. The at least two pulse signals may have pulse repetition rates such that their sampling frequencies have a least common multiple that is as high as possible. The processor 404 may determine frequencies of the acoustic events by taking a fast Fourier transform of the DAS data. The first acoustic event and the second acoustic event may have frequencies that are in-band, that is, frequencies that are included in the Nyquist frequency range.

At block 504, the processor 404 determines a first set of aliased frequencies from the first acoustic event and a second set of aliased frequencies from the second acoustic event. In some examples, if the first acoustic event and the second acoustic event have the same frequencies with no aliasing, that same frequency may be a true frequency. In other examples, the first acoustic event and the second acoustic event may have aliased frequencies. So, the processor 404 may determine at least two frequency bands that are dissimilar between the two fast Fourier transforms. The processor 404 may determine a first set of aliased frequencies that includes all aliased frequencies for the first frequency band, and a second set of aliased frequencies that includes all aliased frequencies for the second frequency band.

At block 506, the processor 404 determines a frequency of an out-of-band signal based on an intersection of the first set of aliased frequencies and the second set of aliased frequencies. If a cardinality of the intersection between the first set of aliased frequencies and the second set of aliased frequencies is one, then the frequency value of the intersection may be the true frequency of an acoustic event detected by an out-of-band signal. If the cardinality is greater than one, and the intersection includes more than one frequency that is beyond the Nyquist frequency, the DAS system may acquire additional DAS data using a light pulse signal with a pulse repetition rate that differs from the pulse repetition rate of the first two light pulse signals. The steps in blocks 502-506 may be repeated with the additional DAS data until a true frequency is determined.

In some aspects, apparatus, method, and system for determining an acoustic event from an out-of-band signal are provided according to one or more of the following examples:

Example #1: A receiver system may include an optical signal receiver for measuring distributed acoustic sensing data from at least two sensed signals received from a sensing fiber deployable in a wellbore, the at least two sensed signals corresponding to at least two light pulse signals outputted by a transmitter to the sensing fiber, wherein the at least two light pulse signals have different pulse repetition rates. The receiver system may include an acoustic event detection processing device for determining at least one acoustic event in the wellbore from an out-of-band signal using the distributed acoustic sensing data by performing operations. The operations may include determining, from the distributed acoustic sensing data, a first acoustic event and a second acoustic event; determining a first set of aliased frequencies from the first acoustic event and a second set of aliased frequencies from the second acoustic event; and determining, using an intersection of the first set of aliased frequencies and the second set of aliased frequencies, a frequency or amplitude of the out-of-band signal that is usable to determine the at least one acoustic event.

Example #2: The receiver system of Example #1 may feature the acoustic event detection processing device being configurable to determine the at least one acoustic event from the out-of-band signal using the first acoustic event and the second acoustic event, the first acoustic event and the second acoustic event being determinable from in-band signals within a frequency band and the at least one acoustic event being determinable from the out-of-band signal outside of the frequency band.

Example #3: The receiver system of any of Examples #1-2 may feature the acoustic event detection processing device being configurable to determine the first set of aliased frequencies and the second set of aliased frequencies by: determining, using fast Fourier transforms, a first frequency from the first acoustic event and a second frequency from the second acoustic event; determining at least one frequency band dissimilar from the first frequency and the second frequency; and determining, based on the at least one frequency band, the first set of aliased frequencies and the second set of aliased frequencies.

Example #4: The receiver system of any of Examples #1-3 may feature the acoustic event detection processing device being configurable to determine the first acoustic event using a first sampling frequency and the second acoustic event using a second sampling frequency, and wherein the first sampling frequency is different from the second sampling frequency.

Example #5: The receiver system of any of Examples #1-4 may feature the acoustic event detection processing device being configurable to determine the frequency of the out-of-band signal by: determining a cardinality of the intersection of the first set of aliased frequencies and the second set of aliased frequencies.

Example #6: The receiver system of any of Examples #1-5 may feature the acoustic event detection processing device being configurable to determine the frequency of the out-of-band signal by: based on determining that the cardinality is one, determining that the frequency of the out-of-band signal is the intersection of the first set of aliased frequencies and the second set of aliased frequencies.

Example #7: The receiver system of any of Examples #1-6 may feature the acoustic event detection processing device being configurable to determine the frequency of the out-of-band signal by: based on determining that the cardinality is greater than one, receiving one or more additional distributed acoustic sensing data using one or more additional sampling frequencies.

Example #8: A method may include determining, by a receiver and from distributed acoustic sensing data detected from at least two sensed signals received from a sensing fiber deployable in a wellbore, a first acoustic event and a second acoustic event, wherein the at least two sensed signals correspond to at least two light pulse signals outputted by a transmitter to the sensing fiber, the at least two light pulse signals having different pulse repetition rates and including an out-of-band signal; determining, by the receiver, a first set of aliased frequencies from the first acoustic event and a second set of aliased frequencies from the second acoustic event; and determining, using an intersection of the first set of aliased frequencies and the second set of aliased frequencies, a frequency of the out-of-band signal.

Example #9: The method of Example #8 can include determining at least one acoustic event from the out-of-band signal using the first acoustic event and the second acoustic event, the first acoustic event and the second acoustic event being determinable from in-band signals within a frequency band and the at least one acoustic event being determinable from the out-of-band signal outside of the frequency band.

Example #10: The method of any of Examples #8-9 may feature determining the first set of aliased frequencies and the second set of aliased frequencies by: determining, using fast Fourier transforms, a first frequency from the first acoustic event and a second frequency from the second acoustic event; determining at least one frequency band dissimilar from the first frequency and the second frequency; and determining, based on the at least one frequency band, the first set of aliased frequencies and the second set of aliased frequencies.

Example #11: The method of any of Examples #8-10 can include determining the first acoustic event using a first sampling frequency and the second acoustic event using a second sampling frequency, and wherein the first sampling frequency is different from the second sampling frequency.

Example #12: The method of any of Examples #8-11 may feature determining the frequency of the out-of-band signal by: determining a cardinality of the intersection of the first set of aliased frequencies and the second set of aliased frequencies.

Example #13: The method of any of Examples #8-12 may feature determining the frequency of the out-of-band signal by: based on determining that the cardinality is one, determining that the frequency of the out-of-band signal is the intersection of the first set of aliased frequencies and the second set of aliased frequencies.

Example #14: The method of any of Examples #8-13 may feature determining the frequency of the out-of-band signal by: based on determining that the cardinality is greater than one, receiving one or more additional distributed acoustic sensing data using one or more additional sampling frequencies.

Example #15: A system can include a a fiber optic sensor deployable in a wellbore for sensing at least two sensed signals comprising distributed acoustic sensing data and a receiver for receiving the at least two sensed signals and configurable to determine at least one acoustic event from an out-of-band signal using the distributed acoustic sensing data by performing operations. The operations can include: determining, from the distributed acoustic sensing data, a first acoustic event and a second acoustic event; determining a first set of aliased frequencies from the first acoustic event and a second set of aliased frequencies from the second acoustic event; and determining, using an intersection of the first set of aliased frequencies and the second set of aliased frequencies, a frequency or amplitude of the out-of-band signal that is usable to determine the at least one acoustic event.

Example #16: The system of Example #15 can include one or more lasers configurable to output at least two light pulse signals at different pulse repetition rates to the sensor, wherein the at least two sensed signals correspond to the at least two light pulse signals.

Example #17: The system of any of Examples #15-16 may feature the receiver being configurable to determine the at least one acoustic event from the out-of-band signal using the first acoustic event and the second acoustic event, the first acoustic event and the second acoustic event being determinable from in-band signals within a frequency band and the at least one acoustic event being determinable from the out-of-band signal outside of the frequency band.

Example #18: The system of any of Examples #15-17 may feature the receiver being configurable to determine the first set of aliased frequencies and the second set of aliased frequencies by: determining, using fast Fourier transforms, a first frequency from the first acoustic event and a second frequency from the second acoustic event; determining at least one frequency band dissimilar from the first frequency and the second frequency; and determining, based on the at least one frequency band, the first set of aliased frequencies and the second set of aliased frequencies.

Example #19: The system of any of Examples #15-18 may feature the receiver being configurable to determine the first acoustic event using a first sampling frequency and the second acoustic event using a second sampling frequency, and wherein the first sampling frequency is different from the second sampling frequency.

Example #20: The system of any of Examples #15-19 may feature the receiver being configurable to determine the frequency of the out-of-band signal by: determining a cardinality of the intersection of the first set of aliased frequencies and the second set of aliased frequencies.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A receiver system comprising:
an optical signal receiver for measuring distributed acoustic sensing data from at least two sensed signals received from a sensing fiber deployable in a wellbore, the at least two sensed signals corresponding to at least two light pulse signals outputted by a transmitter to the sensing fiber, wherein the at least two light pulse signals have different pulse repetition rates; and
an acoustic event detection processing device for determining at least one acoustic event in the wellbore from an out-of-band signal using the distributed acoustic sensing data by:
determining, from the distributed acoustic sensing data, a first acoustic event and a second acoustic event;
determining a first set of aliased frequencies from the first acoustic event and a second set of aliased frequencies from the second acoustic event; and
determining, using an intersection of the first set of aliased frequencies and the second set of aliased frequencies, a frequency or amplitude of the out-of-band signal that is usable to determine the at least one acoustic event.

2. The receiver system of claim 1, wherein the acoustic event detection processing device is configurable to determine the at least one acoustic event from the out-of-band signal using the first acoustic event and the second acoustic event, the first acoustic event and the second acoustic event being determinable from in-band signals within a frequency band and the at least one acoustic event being determinable from the out-of-band signal outside of the frequency band.

3. The receiver system of claim 1, wherein the acoustic event detection processing device is configurable to determine the first set of aliased frequencies and the second set of aliased frequencies by:
determining, using fast Fourier transforms, a first frequency from the first acoustic event and a second frequency from the second acoustic event;
determining at least one frequency band dissimilar from the first frequency and the second frequency; and
determining, based on the at least one frequency band, the first set of aliased frequencies and the second set of aliased frequencies.

4. The receiver system of claim 1, wherein the acoustic event detection processing device is configurable to determine the first acoustic event using a first sampling frequency and the second acoustic event using a second sampling frequency, and wherein the first sampling frequency is different from the second sampling frequency.

5. The receiver system of claim 4, wherein the acoustic event detection processing device is configurable to determine the frequency of the out-of-band signal by:
determining a cardinality of the intersection of the first set of aliased frequencies and the second set of aliased frequencies.

6. The receiver system of claim 5, wherein the acoustic event detection processing device is configurable to determine the frequency of the out-of-band signal by:
based on determining that the cardinality is one, determining that the frequency of the out-of-band signal is the intersection of the first set of aliased frequencies and the second set of aliased frequencies.

7. The receiver system of claim 6, wherein the acoustic event detection processing device is configurable to determine the frequency of the out-of-band signal by:
based on determining that the cardinality is greater than one, receiving one or more additional distributed acoustic sensing data using one or more additional sampling frequencies.

8. A method comprising:
determining, by a receiver and from distributed acoustic sensing data detected from at least two sensed signals received from a sensing fiber deployable in a wellbore, a first acoustic event and a second acoustic event, wherein the at least two sensed signals correspond to at least two light pulse signals outputted by a transmitter to the sensing fiber, the at least two light pulse signals having different pulse repetition rates and including an out-of-band signal;
determining, by the receiver, a first set of aliased frequencies from the first acoustic event and a second set of aliased frequencies from the second acoustic event; and
determining, using an intersection of the first set of aliased frequencies and the second set of aliased frequencies, a frequency of the out-of-band signal.

9. The method of claim 8, wherein the method further comprises determining at least one acoustic event from the out-of-band signal using the first acoustic event and the second acoustic event, the first acoustic event and the second acoustic event being determinable from in-band signals within a frequency band and the at least one acoustic event being determinable from the out-of-band signal outside of the frequency band.

10. The method of claim 8, wherein determining the first set of aliased frequencies and the second set of aliased frequencies further comprises:
determining, using fast Fourier transforms, a first frequency from the first acoustic event and a second frequency from the second acoustic event;
determining at least one frequency band dissimilar from the first frequency and the second frequency; and
determining, based on the at least one frequency band, the first set of aliased frequencies and the second set of aliased frequencies.

11. The method of claim 8, further comprising determining the first acoustic event using a first sampling frequency and the second acoustic event using a second sampling frequency, and wherein the first sampling frequency is different from the second sampling frequency.

12. The method of claim 11, wherein determining the frequency of the out-of-band signal further comprises:
determining a cardinality of the intersection of the first set of aliased frequencies and the second set of aliased frequencies.

13. The method of claim 12, wherein determining the frequency of the out-of-band signal further comprises:
based on determining that the cardinality is one, determining that the frequency of the out-of-band signal is the intersection of the first set of aliased frequencies and the second set of aliased frequencies.

14. The method of claim 13, wherein determining the frequency of the out-of-band signal further comprises:
based on determining that the cardinality is greater than one, receiving one or more additional distributed acoustic sensing data using one or more additional sampling frequencies.

15. A system comprising:
a fiber optic sensor deployable in a wellbore for sensing at least two sensed signals comprising distributed acoustic sensing data; and
a receiver for receiving the at least two sensed signals and configurable to determine at least one acoustic event from an out-of-band signal using the distributed acoustic sensing data by:
determining, from the distributed acoustic sensing data, a first acoustic event and a second acoustic event;
determining a first set of aliased frequencies from the first acoustic event and a second set of aliased frequencies from the second acoustic event; and
determining, using an intersection of the first set of aliased frequencies and the second set of aliased frequencies, a frequency or amplitude of the out-of-band signal that is usable to determine the at least one acoustic event.

16. The system of claim 15, further comprising one or more lasers configurable to output at least two light pulse signals at different pulse repetition rates to the sensor, wherein the at least two sensed signals correspond to the at least two light pulse signals.

17. The system of claim 15, wherein the receiver is configurable to determine the at least one acoustic event from the out-of-band signal using the first acoustic event and the second acoustic event, the first acoustic event and the second acoustic event being determinable from in-band signals within a frequency band and the at least one acoustic event being determinable from the out-of-band signal outside of the frequency band.

18. The system of claim 15, wherein the receiver is configurable to determine the first set of aliased frequencies and the second set of aliased frequencies by:
determining, using fast Fourier transforms, a first frequency from the first acoustic event and a second frequency from the second acoustic event;
determining at least one frequency band dissimilar from the first frequency and the second frequency; and
determining, based on the at least one frequency band, the first set of aliased frequencies and the second set of aliased frequencies.

19. The system of claim 15, wherein the receiver is configurable to determine the first acoustic event using a first sampling frequency and the second acoustic event using a second sampling frequency, and wherein the first sampling frequency is different from the second sampling frequency.

20. The system of claim 19, wherein the receiver is configurable to determine the frequency of the out-of-band signal by:
determining a cardinality of the intersection of the first set of aliased frequencies and the second set of aliased frequencies.
